(19) United States
(12) Patent Application Publication
(10) Pub. No.: US 2010/0167612 A1
(43) Pub. Date: Jul. 1, 2010

(54) MULTILOBAL FILAMENT, FABRICS AND PROCESS FOR MAKING THE SAME

(76) Inventors: Vikas Madhusudan Nadkarni, Maharashtra (IN); Santosh Raghavendra Huilgol, Maharashtra (IN); Manoj Jhaver, Maharashtra (IN); Makarand Renukadas Megde, Maharashtra (IN)

Correspondence Address: KLEIN, O''Neill & SINGH, LLP, 18200 Von Karman Avenue, Suite 725, IRVINE, CA, 92612, US

(21) Appl. No.: 12/063,419

(22) PCT Filed: Aug. 8, 2006
(86) PCT No.: PCT/IN06/00294

§ 371 Date: Feb. 8, 2008

(30) Foreign Application Priority Data
Aug. 10, 2005 (IN) 932/MUM/2005

(51) Int. Cl. B32B 5/02; D02G 3/38; D01D 5/32

(52) U.S. Cl. 442/60; 428/373; 264/172.14

(57) ABSTRACT

Method for producing multilobal bicomponent fiber or filaments comprising spinning at least two polymer components by bicomponent spinning system through round capillary to obtain fibers or filaments and treating fibers or filaments with hot alkali to obtain multilobal bicomponent fibers or filaments. Alternatively fabric is produced from the bicomponent fibers or filaments and treated it with hot alkali to obtain fabric comprising multilobal bicomponent fibers or filaments uniformly distributed in the matrix. The wicking property of multilobal bicomponent fibers or filaments or fabric comprising the same improved with respect to standard polyester of equivalent denier.

### FIELD OF THE INVENTION

The invention relates to a method of producing multilobal fibres through a round capillary on a bicomponent spinning system. Particularly the present invention relates to a method of producing the multilobal filaments/fibres which in turn impart moisture management properties to the filaments/fibres due to higher surface area per unit volume and capillary action through the multiple microchannels.

The invention also relates to multilobal fibres or filaments produced through a round capillary on a bicomponent spinning system by the above-mentioned process.

### BACKGROUND OF THE INVENTION

A number of methods were suggested in the prior art to get good wicking properties and one of the routes was modifying the cross section of the yam. JP 2005265883 discloses producing multilobal filament cross section for use in toothbrush bristles. The capillary geometry was modified to get the lobes.

JP 2005105434 discloses producing multilobal fibres by using polyester as core and copolyester as lobes.

JP 2004285493 discloses use of elastic fibres as core and polyamide fibres with a multilobal cross-section as sheath. This is followed by dissolution stage where PET gets washed away as a result of treatment with hot concentrated alkali.

JP 2004124306 discloses use of block copolymer of poly(butylene terephthalate) and poly(trimethylene terephthalate) to produce multilobal fibres.

JP 2002129433 discloses side-by-side bicomponent filaments extruded through tetralobal cross section capillary geometry wherein the two polymers being poly(trimethylene terephtahlate) of different molecular weights. The resultant fibres will have bulk and moisture management properties.

JP 2002058538 disclose multilobal cross section poly(butylene terephthalate) monofilament yarns. Again the route of capillary modification was followed.

U.S. Pat. No. 6,815,383 disclose bicomponent multilobal fibres wherein the two different polymers with difference in melting points were used. The principal application is into thermal bonding.

JP 2000154461 disclose using two polymers differing in their rate of solubility in hot alkali solution for getting specialty fibres. The multilobal fibres were thinned in hot alkali. The advantage of use of inorganic particles is also illustrated.

JP 11279897 disclose producing ‘tooth’ shaped cross section fibres wherein the use of poly(ethylene terephthalate) and its copolymer having differential shrinkage for producing specialties is demonstrated.

JP 09067765 discloses fabrics produced by blending fibres consisting of filaments with differing rates of solubility are illustrated.

JP 08134732 disclose crimpable composite fibres and fibres with weight reduction forming a multilobal cross section comprising poly(ethyelene terephthalate) and 5-sodiosulphoisophthalic acid were used.

JP 010140008 disclose producing bicomponent fibres through a ring shaped capillary by using poly(ethyleneterephthalate) and copolymer of the same. The PET was dissolved completely by high concentration alkali to give out fabric with good hygroscopycity.

EP 399397 discloses sheath core spinning of multilobal conductive filaments. In this invention, the conductive material is used in the core and the cross section is multilobal by design.

JP 2005076142 disclose producing nonwoven fabrics produced by filaments comprising of poly(lactic acid) and aliphatic polyesters through a capillary to give multilobal fibres.

All the above-mentioned prior arts were primarily focused on modifying the filament cross section by means of modifying the capillary geometry to get the filaments of desired cross section. The prior arts comprised of production of multilobal fibres and filaments by modifying the spinneret capillary geometry. The number of channels attempted was 4 (tetralobal), 6 (hexalobal) or 8 (octalobal). In order to realize the multilobal filament cross section through such non-round capillaries, stringent control of spinning process parameters, such as, melt temperature, quench air temperature and velocity profile, etc. is required. Added to this, when the multilobal filaments are texturised, they tend to lose their perfect lobe structure thus the realization is not full. Moreover, one needs to maintain adequate inventory of spinnerets for all the capillary types to produce different fibre cross sections.

The prior arts also comprise use of two polymers with varying rates of solubility and completely dissolving one component in high concentration hot alkali treatment. The prior arts also disclose producing bicomponent fibres in side-by-side bicomponent geometry through a non-round capillary cross section. The resultant fibres give good wicking properties along with bulk.

Any discussion of the prior art throughout the specification should in no way be considered as an admission that such prior art is widely known or forms part of the common general knowledge in the field.

### OBJECTS OF THE INVENTION

An object of the invention is to provide a process for producing multilobal fibers or filaments through round capillary by bicomponent spinning system.

Another object of the invention is to provide a process for producing multilobal fibers or filaments through round capillary by bicomponent spinning system where the process is simple, easy and convenient to carry out.

Another object of the invention is to provide multilobal fibers or filaments by the above mentioned process.

Another object of the invention is to provide multilobal fibers or filaments by the above mentioned process where the fibers or filaments have good wicking property.

Another object of the invention is to provide multilobal fibers or filaments by the above mentioned process where the fibers or filaments have uniform dyeing property.

Another object of the invention is to provide a process for producing fabric comprising uniformly distributed fibers or filaments in the matrix and having good wicking property and uniform dyeing property.

Another object of the invention is to provide fabric comprising uniformly distributed fibers or filaments prepared by the above process and have good wicking property and uniform dyeing property.

### DETAILED DESCRIPTION OF THE INVENTION:

According to the invention there is provided a method for producing multilobal fibers or filaments comprising
(A) spinning at least two polymers by bicomponent spinning system through round capillary to obtain fibers or filaments; and
(B) treating fibers or filaments with hot alkali to obtain multilobal fibers or filaments.
   According to the invention there is provided method for producing fabric comprising multilobal fibers or filaments comprising
(A) spinning at least two polymers by bicomponent spinning system through round capillary to obtain fibers or filaments;
(B) converting the fibers or filaments of step (A) into fabric by knitting, weaving or tufting. and
(C)treating the fabric with hot alkali to obtain fabric comprising multilobal fibers or filaments uniformly distributed in matrix.

The two polymers were selected in such a way that the degree of adhesion between the two polymers is very high so that the segments will not separate out during downstream processes or when in use but still they are different in their extent of response for the chemical treatments. The two polymer components of the bicomponent fibers or filament have different rates of hydrolysis. At least one of the polymers is suitably chemically modified so as to have sufficient difference in the rate and degree of hydrolysis. The second polymer is the one with higher rate of hydrolysis in hot alkali solution. The two polymers preferably selected from the same class or type but differing in their response to the various wet processing conditions.

In one aspect according to the present invention the two polymers were selected from the same class having the same basic chemistry but at least one component was suitably modified so as to change the response towards hot chemical treatment, as regards different rates of hydrolysis. The response attribute may be loss in weight, surface etching, etc. The direction of the response depends on the type of modification done in the process, nature of the additive used and the extent or severity depends on the concentration of the additive, polymer chemistry, reactivity levels, etc.

Preferably, at least one polymer component of the bicomponent fibres or filament is selected from polyester or polyester based copolymer or polyamide. More preferably, the polymer is poly(ethylene terephthalate) or polybutylene terephthalate) or Poly(tetra-methylene terephthalate) or copolymer thereof or polyamides. The second polymer component of the bicomponent fibres or filaments is selected from polyester or polyamide or copolymers thereof or blends thereof. Preferably at least one of the polymer components of the bicomponent fibers or filament is modified by adding sodium salt of 5-sulphoisophthalic acid, silica, polyethylene glycols or polypropylene glycols or combinations thereof to get hydrophilic properties or any other polymer which is faster soluble/hydrolysable in hot alkali.

Preferably, at least one of the polymer components of the bicomponent fibers or filament is modified by adding sodium-5-isophthalate or silica as additive in the range of 1% to 10%. Particle size of silica is in the order of nano scale to micro scale. Preferably, the two polymer components of the bicomponent fibers or filaments are used in the ratio of 25:75 to 75:25. Preferably, the two polymer components of the bicomponent fibers or filaments are used in the ratio of 50:50 wt/wt. Preferably, the intrinsic viscosity of the two polymer components of the bicomponent fibers or filament is in the range of 0.40 to 1.00.

Preferably, two polymer components of the bicomponent fibers or filament are arranged in bicomponent segmented pie geometry with 8 to 128 segments, preferably 16 to 32 segments. Preferably, the bicomponent fibers or filaments have solid round or hollow round cross section or combinations thereof. Preferably the bicomponent fiber or filament is treated with 0.5-10% alkali solution at a temperature of 60 to 130° C. to obtain multilobal bicomponent fibers or filaments. Preferably the fabric comprising the bicomponent fibers or filaments is treated with 0.5-10% alkali solution at a temperature of 60 to 130° C. to obtain multilobal bicomponent fibers or filaments uniformly distributed in fabric matrix.

Preferably the multilobal bicomponent fibers or filaments have wicking property in the range of 2.4 cm to 3.0 cm before washing and 0.4 cm to 0.8 cm after washing. Preferably the fabric comprising multilobal bicomponent fibers or filaments uniformly distributed in the matrix has wicking property in the range of 2.4 cm to 3.0 cm before washing and 0.4 cm to 0.8 cm after washing.

The method of producing multilobal fibers or filament is a single stage process [Fully drawn yarn (FDY)] or a two stage process [partially oriented yarn and further draw texturing (POY+Draw Texturing) or partially oriented yarn and further draw twisting (POY+Draw Twisting)], or partially oriented yarn and further air texturing (POY+Air Texturing)

The filaments thus produced are converted into any fabric form like knit, woven etc after optionally twisting and heat setting the yarns.

The two polymers were extruded separately in separate extruders at a temperature 20° C. to 45° C. above the melting point of each polymer. The polymers were passed from extruder to spin beam through manifold and entered into the spinpack to obtain the segmented pie bicomponent geometry. In this geometry the two neighboring components were of different type.

The yarn was optionally processed through a routine twisting process where the filaments were twisted to any level from zero to 2400 turns/meter to get the desired attributes in the fabric. Once the fabric was formed by means of either knitting (warp knitting or circular knitting) or weaving, the same was subjected to hot chemical treatment where the filament cross-sectional modification takes place.

The bicomponent fibers or filaments or fabric comprising the bicomponent fibers or filaments is treated with hot alkali solution preferably 0.5-10% alkali solution at a temperature of 60° C. to 130° C. for a period of 10 minutes to 60 minutes. As a result of differential hydrolyzability of the polymers, lobes get formed in alternate segments rendering gear like cross section.

Differential etching or cross sectional modification of the two adjoining segments was achieved along the length of yarn thus resulting into a completely different cross section of the yam. The hot chemical treatment resulted in differential surface etching of the two polymer components of the segmented-pie cross section of the filament.

The lobe depth of multilobal filament achieved by the hot solvent treatment is found to be the function of concentration of co-monomer additive in the polymer, hot chemical concentration, time and temperature.

It has been observed that up to a certain time of treatment there was no effect of hot chemical treatment but after the threshold the lobe started getting shape. At optimum level of chemical concentration, time and temperature, the sufficient weight reduction took place by the way of forming lobes. It is obvious that excessive or harsh chemical treatment mars the objective.

The condition used in the alkali treatment depends on the type of polymers, their preferred response to the alkali, level of modification, type of polymer blends etc.

According to the present invention, the hot treatment conditions may be adjusted to achieve desired total denier, denier per filament, extent of wicking required for getting the required moisture management properties, etc.

Any person skilled in the art can modify or alter the hot treatment conditions and achieve different or desired denier, denier per filament, extent of wicking or moisture management properties.

According to the invention there is provided multilobal fibers or filaments having improved wicking properties vs. standard polyester prepared by the above mentioned method.

According to the invention there is provided fabric comprising multilobal fibers or filaments having improved wicking properties vs standard polyester prepared by the above-mentioned method.

The bicomponent fibers or filaments or fabrics comprising the same were treated in hot alkali solution to get the characteristic channels or lobes. The numbers of channels or lobes generated after the chemical treatments was depending on the number of segments in a pie configuration. The number of channels or lobes generated according to the present invention can be 4, 8, 16, 32 or 64. A specific experiment was carried out to get 8 lobes after treatment. The pack configuration will be different for each of these. The selection of the number of lobes depends on the targeted wicking attributes, filament denier and denier per filament, filament processing route, etc.

The bicomponent yarn is dyed by disperse dye and both the components get uniformly dyed.

The luster of the two polymers was semidull. But it can be any combination of superbright, bright, semi-dull or full dull. Superbright luster can be achieved without adding any titanium dioxide, bright luster may achieved by adding titanium dioxide upto 0.05%, semi dull luster may achieved by adding titanium dioxide or barium sulphate about 0.27 to 0.33% and full dull luster may be achieved by adding titanium dioxide or barium sulphate or combinations thereof about 2.2%. The selection depends on specific targeted product.

The lobes are getting formed in the filaments when they go into the fabric thus realization is full and complete.

Thus the method of the invention produces multilobal fibres or filaments through a solid or hollow round spinneret geometry in a bicomponent spinning system, which will give excellent moisture management properties. The alkali treatment does not involve any critical conditions. The process is very simple, easy and convenient to carry out because no inventory of expensive spinnerets is needed, hydrolysis conditions are mild, hydrolysis can be carried out on the existing equipment commonly available with polyester fabric processors, and the copolymers are inexpensive. The fabric produced by the method of the invention comprises fibers or filaments uniformly distributed in the matrix having excellent wicking properties and uniform dyeing ability. The filtration fabrics made of such multilobal fibres and filaments would provide higher dust holding capacity.

Although the invention has been described with reference to specific examples, it will be appreciated by those skilled in the art that the invention may be embodied in many other forms.

### Example 1

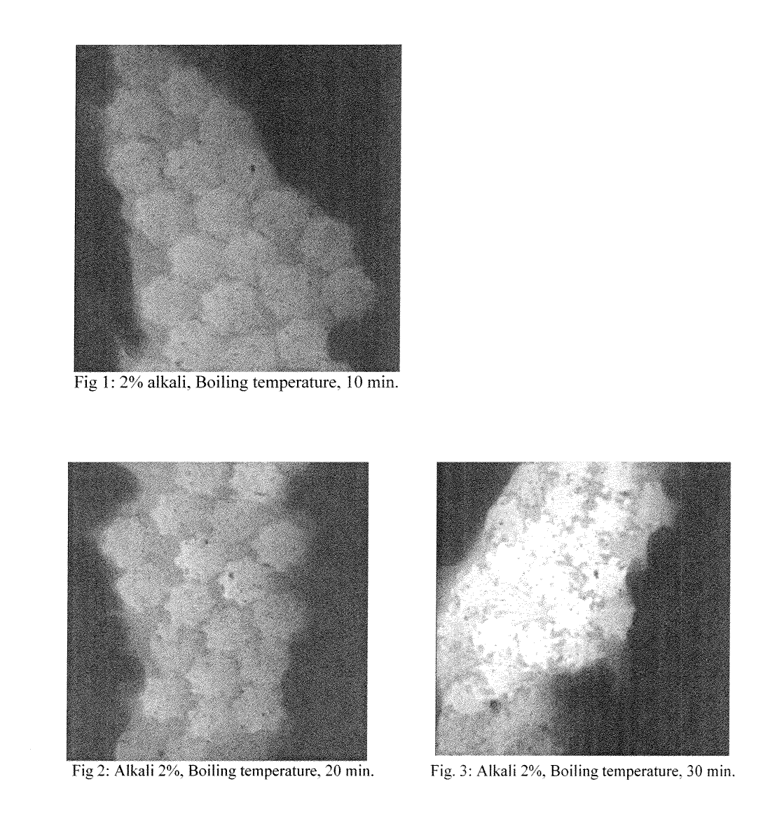

A fully drawn yarn was produced on a bicomponent spinning system with two polymers poly(ethylene terephthalate) and poly(ethylene terephthalate) modified by 3.7% by weight by sodium salt of isophthalic acid. A final denier of 75/36 set yarn was produced. The polymer ratio of polyester and co-polyester was 50:50. The total number of segments was 16, out of which 8 segments of each polymer were placed alternatively. The filament was knitted on a single-end knitting machine to obtain fabric. The fabric was treated with 2% alkali solution at boiling temperature for 10 min, 20 min and 30 min respectively. The lobe structure thus developed was confirmed by optical microscope and by Electron Microscope. FIGS. 1, 2 and 3 illustrate the optical microscopic lobe structure developed on hot alkali treatment i.e by using 2% alkali solution at boiling temperature after 10, 20 and 30 minutes respectively. Thus filament, which was originally round in cross section converted into a multilobal filament after alkali treatment. The alkali treated fabric was then subjected to wicking test before and after wash. The wicking property of the fabric was in the range of 2.4 cm to 3.0 cm before washing and 0.4 cm to 0.8 cm after washing.

We claim:

1. Method for producing multilobal bicomponent fiber or filaments, the process comprising
(A) spinning at least two polymer components by bicomponent spinning system through round capillary to obtain fibers or filaments; and
(B) treating fibers or filaments with hot alkali to obtain multilobal bicomponent fibers or filaments.

2. Method for producing fabric comprising multilobal bicomponent fiber or filaments,
the process comprising
(A) spinning at least two polymer components by bicomponent spinning system through round capillary to obtain bicomponent fibers or filaments;
(B) converting the bicomponent fibers or filaments of step (A) into fabric by knitting, weaving or tufting etc. and
(C) treating the fabric with hot alkali to obtain fabric comprising multilobal bicomponent fibers or filaments uniformly distributed in the matrix.

3. Method as claimed in claim 1 or 2, wherein two polymer components of bicomponent fibers or filament have different rate of hydrolysis.

4. Method as claimed in claim 1 or 2, wherein at least one polymer component of the bicomponent fibers or filaments is selected from polyester or polyester based copolymer or polyamide and second polymer component of the bicomponent fibers or filaments is selected from polyester or polyamide or copolymers thereof or blends thereof.

5. Method as claimed in claim 1 or 2, wherein at least one polymer component of the bicomponent fibers or filaments is modified by adding sodium-5-isophthalate, silica, polyethylene glycol or polypropylene glycol or combinations thereof in the range of 1% to 10%, or combinations thereof.

6. Method as claimed in claim 1 or 2, wherein two polymer components of the bicomponent fibers or filaments are used in the ratio of 25:75 to 75:25.

7. Method as claimed in claim 1 or 2, wherein two polymer components of the bicomponent fibers or filaments are arranged in bicomponent segmented pie geometry with 8 to 128 segments, preferably 16 to 32 segments.

8. Method as claimed in claim 1 or 2, wherein the bicomponent fibers or filaments have solid round or hollow round cross section or combinations thereof.

9. Method as claimed in claim 1, wherein the bicomponent fibers or filaments is treated with 0.5-10% alkali solution at a temperature of 60 to 130° C. to obtain multilobal bicomponent fibers or filaments.

10. Method as claimed in claim 2, wherein the fabric comprising the bicomponent fibers or filaments is treated with 0.5-10% alkali solution at a temperature of 60 to 130° C. to obtain multilobal bicomponent fibers or filaments uniformly distributed in fabric matrix.

11. Method as claimed in claim 1, wherein the multilobal bicomponent fibers or filaments have improved wicking property vs. standard polyester.

12. Method as claimed in claim 2, wherein the fabric comprising multilobal bicomponent fibers or filaments uniformly distributed in the matrix has improved wicking property vs standard polyester.

13. Multilobal bicomponent fibers or filaments having: improved wicking property vs standard polyester produced by the method as claimed in claims 1 and 3 to 9.

14. Multilobal bicomponent fibers or filaments as claimed in claim 13, wherein at least one polymer component of the bicomponent fibres or filaments is selected from polyester or polyamide and the second polymer component of the bicomponent fibres or filaments is selected from polyester or polyamide or copolymers thereof or blends thereof.

15. Multilobal bicomponent fibers or filaments as claimed in claim 13, wherein at least one polymer component of the bicomponent fibers or filaments is modified by adding silica, polyethylene glycol or polypropylene glycol or combinations thereof in the range of 1% to 10%.

16. Multilobal bicomponent fibers or filaments as claimed in claim 13, wherein two polymer components of the bicomponent fibres or filaments are used in the ratio of 25:75 to 75:25.

17. Multilobal bicomponent fibers or filaments as claimed in claim 13, wherein two polymer components of the bicomponent fibres or filaments are arranged in bicomponent segmented pie geometry with 8 to 128 segments preferably 16 to 32 segments.

18. Multilobal bicomponent fibers or filaments as claimed in claim 13, wherein the bicomponent fibers or filaments have solid round or hollow round cross section or combinations thereof.

19. Fabric comprising multilobal bicomponent fibers or filaments uniformly distributed in matrix and having improved wicking property vs. standard polyester as claimed in claims 11 to 16 produced by the method as claimed in claims 2, 3 to 8 and 10.
